(19) United States
(12) Patent Application Publication
(10) Pub. No.: US 2015/0292181 A1
(43) Pub. Date: Oct. 15, 2015

(54) Hydrostatic Drive

(71) Applicant: Robert Bosch GmbH, Stuttgart (DE)

(72) Inventors: Oliver Graf, Neu-Ulm (DE); Iain Edward, Kelty (GB)

(21) Appl. No.: 14/680,886

(22) Filed: Apr. 7, 2015

(30) Foreign Application Priority Data
Apr. 10, 2014 (DE) 10 2014 206 891.6

(51) Int. Cl. E02F 9/12; F15B 11/02; F15B 13/02; E02F 9/22

(52) U.S. Cl. CPC E02F 9/123; E02F 9/2264; E02F 9/2267; F15B 11/02; F15B 13/025; F15B 2211/75; F15B 2211/20507

(57) ABSTRACT

Disclosed is a hydrostatic drive for a slewing gear of a stationary or mobile work machine, comprising a first hydraulic machine, a second hydraulic machine, an inflow channel fluidly connecting the first and second hydraulic machines, a return flow channel fluidly connecting the second hydraulic machine to a pressure medium sink, and a feed connection for compensating a leakage or a differential volume flow. The feed connection is selectively fluidly connected to whichever of the inflow channel and a return flow channel having higher pressure.

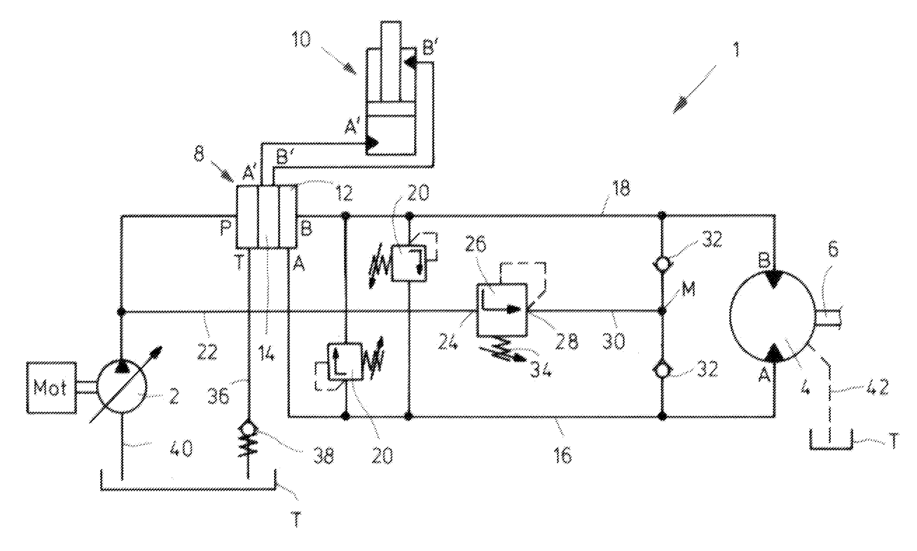

This application claims priority under 35 U.S.C. § 119 to patent application no. DE 10 2014 206 891.6, filed on Apr. 10, 2014 in Germany, the disclosure of which is incorporated herein by reference in its entirety.

The disclosure relates to a hydrostatic drive for a slewing gear.

### BACKGROUND

The drive of the generic type is employed, in particular, in a mobile work machine, for instance an excavator or crane. It has a hydrostatic pump, via which a hydrostatic motor of the drive can be supplied with pressure medium. The motor here serves to drive the slewing gear. The pump and the motor, in particular when still further hydrostatic work machines can be supplied via the pump, are arranged in an open hydraulic circuit. For the supply of pressure medium, they are connected to one another via an inflow, wherein the return flow of the motor is connectable to pressure medium sink of the drive, for instance a tank.

In order to compensate a leakage or a differential volume flow between the inflow circuit and the return flow, the drive has a feed connection, which can be fluidically connected both to the inflow and to the return flow, for instance via a respective check valve. If the pressure in the inflow or return flow falls, in dependence on an operating situation, far enough below the pressure at the feed connection, then the feed connection enters into pressure medium connection with the pressure medium channel in question, so that pressure medium can be replenished.

Besides the compensation for the leakage or the differential volume flow, the hydraulic circuit can also in this way be protected against cavitation, which can occur if the inflow/return flow pressure is too low.

In a number of traditional solutions of the generic type, the feed connection is in pressure medium connection with a tank line and the feed-in takes place via check valves which open from the tank line toward the corresponding pressure medium channel. Since for energy-related reasons, however, a pressure of the tank line is kept as low as possible, for instance at about three bar, it can happen that for a high replenishment requirement (high leakage or very low pressure in the inflow/return flow) a drop in pressure via the check valve, and thus a replenishment volume flow, is inadequate. That can lead to undesirable operating behavior of the drive and to harmful cavitation in the inflow/return flow in question and in the linked hydrostatic components.

This risk is particularly high if the slewing gear is braked sharply out of its rotary motion. In the pressure medium channel of the hydraulic motor, which up to that point operates as an inflow, a sharp drop in pressure then ensues and a high pressure drop between the feed connection and the pressure medium channel is required in order to securely prevent cavitation.

A traditional solution according to the generic type is shown by printed publication JP 2002 257 101. It has the discussed embodiment of the feed line realized as a tank line and the aforementioned high risks of cavitation.

A comparable concept with respect to the replenishment is shown by patent U.S. Pat. No. 6,339,929 B1.

Printed publication U.S. Pat. No. 7,856,819 B2 teaches for the replenishment function the use of a hydraulic apparatus denoted as a pressure reducer. Its pressure medium inlet is connected to the hydraulic pump, and the pressure medium outlet to a connection of the hydraulic motor. Moreover, the pressure medium outlet is in constant pressure medium connection, via a valve arrangement, with a return flow line connected to a tank. A drawback with this is that a constant feed-out of this kind is realized via the pressure reducer, which constitutes an energy loss. It remains unclear how the pressure is defined at the outlet of the pressure reducer. It cannot be inferred from the printed publication whether the connection can be connected up to the inflow or return flow.

Printed publication EP 2 514 978 A2 shows a hydrostatic drive having a hydraulic apparatus, designated as a pressure retention valve, via which, on the one hand, a pressure medium store connected to the feed connection is filled and, on the other hand, a control pressure network of the drive is supplied with pressure medium. Unlike in the preceding examples, the tank line is here not simultaneously configured as a feed line, but is fluidically separated therefrom. The way in which the apparatus fulfils these two different functions is left open.

### SUMMARY

In contrast, the object of the disclosure is to provide a hydrostatic drive having a defined feed pressure medium supply.

This object is achieved by a hydrostatic drive of the present disclosure. Advantageous embodiments of the disclosure are described application, claims and the figure.

A hydrostatic drive for a slewing gear of a stationary or mobile work machine, in particular an excavator or crane, has a first hydraulic machine, which can be coupled with a prime mover, and a second hydraulic machine, which can be coupled with the slewing gear. The hydraulic machines are fluidically connected to each other via an inflow channel, wherein the second hydraulic machine can be supplied with pressure medium by the first one. Via a return flow channel of the hydrostatic drive, the second hydraulic machine, for the evacuation of pressure medium, can be connected to a pressure medium sink, in particular a tank of the drive. Furthermore, the drive has a feed connection, in particular for compensating a leakage or a differential volume flow between the inflow channel and the return flow channel, via which the first hydraulic machine can be fluidically connected to that of the two channels which has the lower pressure of the two. According to the disclosure, the drive has a pressure reducing valve having a pressure medium inlet, which can be fluidically connected to the first hydraulic machine, and a pressure medium outlet, which can be fluidically connected to the feed connection. Via the pressure reducing valve, a pressure at the pressure medium outlet, or a pressure which is dependent thereon, in particular a feed pressure which is present at the feed connection, can here be purposefully regulated.

The targeted control intervention of the pressure reducing valve serves to ensure that a defined pressure, the feed pressure, is present at the feed connection. This is preferably regulated such that, for relevant operating states of the drive, a sufficient pressure drop exists from the feed connection toward the inflow or return flow—depending on which of the two has the lower pressure—and a lack of pressure or pressure medium is so rapidly equalized by replenishment that no cavitation occurs. Also, for the particularly critical operating state of an abrupt braking of the slewing gear, if, for instance, the return flow is abruptly shut off, so that consequently the pressure in the inflow falls sharply, then cavitation is prevented by means of the pressure reducing valve.

Through the use of the pressure reducing valve and the assured rapid replenishment, in addition to the cavitation a noise development in structures connected to the drive, which noise development can be observed in solutions having less effective replenishment, is prevented or at least reduced. As thereby affected structures can be cited, in particular, the slewing gear or superstructures supported by the slewing gear.

The pressure reducing valve constitutes a solution which is particularly simple in terms of equipment.

The pressure medium inlet is preferably connectable, in particular connected, to a high pressure side of the first hydraulic machine or of another pressure medium source of the drive.

Preferably, via the two hydraulic machines, the inflow, the return flow and the pressure medium sink, an open hydraulic circuit is formed. Here, a low pressure connection of the first hydraulic machine is preferably fluidically connectable, in particular connected, to the pressure medium sink.

Preferably, the second hydraulic machine can be operated in both rotational directions. Following a reversal of the rotational direction, the former inflow channel then assumes the function of the return flow channel and the former return flow channel assumes the function of the inflow channel.

With the context of this printed publication, the term “channel” is understood to mean a space in which a pressure medium flow path can be formed. It can be configured, for instance, as a line, tube, bore, or the like.

The pressure reducing valve usually has a valve body which is loaded, in the direction of a fluidic separation of the pressure medium inlet from the pressure medium outlet, by the pressure at the pressure medium outlet. In the direction of a fluidic connection of the pressure medium inlet to the pressure medium outlet, the valve body is subjected to a force, the pressure equivalent of which corresponds to the desired value of the pressure at the pressure medium outlet. In the case of a non-adjustable pressure reducing valve, the force is usually exerted by a spring, which can be adjustable. Should the force, and thus the pressure at the pressure medium outlet, be variable, then a proportional electromagnet can be made to act on the valve body, with or without a spring.

In a preferred embodiment, the pressure medium outlet of the pressure reducing valve, at least in a normal operating state of the drive, is fluidically separable or separated from the pressure medium sink. Hence, at least for normal operation, both pressure levels, that of the pressure medium sink and that of the feed pressure, can be chosen independently of each other, so that the layout of the hydraulic circuit and its components is simplified. Added to this is the fact that such a continuous, parasitic pressure medium volume flow away from the feed connection toward the pressure medium sink, as is obtained, for instance, according to the teaching of printed publication U.S. Pat. No. 7,856,819 B2, is prevented.

Apart from this, it is of course possible that, in particular for an extraordinary operating state, for instance for an emergency shutdown, an emergency unloading of the feed connection, maintenance work on the drive, or similar, a pressure medium connection of the pressure medium outlet to the pressure medium sink can be provided.

In a preferred embodiment, the pressure medium outlet, at least in a normal operating state of the drive, is intended solely to supply pressure medium to the feed connection and is fluidically connectable or connected only to said feed connection. Compared to the teaching of printed publication EP 2 514 978 A2, in which the so-called pressure retention valve, in addition to the provision of the feed pressure medium at the required feed pressure, must also provide the control pressure medium of a control pressure network at the required control pressure, this embodiment has the advantage that the feed pressure can be regulated specifically to its individually required level, independently of other requirements.

In one variant, the pressure equivalent is fixed via the spring or via the electromagnet. Alternatively, the spring or the electromagnet can be designed such that the pressure equivalent is adjustable, i.e. variable, via the spring or the electromagnet. Since the pressure equivalent constitutes the desired value of the pressure, in particular the feed pressure, the desired value can in this way be adapted, for instance, to altered operating conditions of the drive.

In a preferred embodiment, the drive has a continuously adjustable control valve for controlling the supply of pressure medium to the second hydraulic machine. The control valve here has a valve bore, in which a valve slide is displaceably accommodated and which has a plurality of radially extended annular spaces. Of these, a high pressure space is fluidically connectable, in particular connected, to the first hydraulic machine, in particular to the high pressure side thereof, an inflow space to the inflow channel, a return flow space to the return flow channel, and a low pressure space to the pressure medium sink. Control edges of the valve slide, in particular of radially extended control collars of the valve slide, and control edges of the annular spaces are here mutually coordinated in such a way that, along an initial stroke of the valve slide out of a neutral position, the inflow space and the return flow space are fluidically connected to the high pressure space and separated from the low pressure space. It is thus ensured, when starting up the first hydraulic machine, that the pump pressure can initially build up in the inflow and in the return flow. Since the feed pressure delivered by the pressure reducing valve is preferably regulated to a lower pressure value than the pump pressure, the creation of an unnecessary feed-in and of a fluidic short circuit from the feed connection, via the return flow, to the pressure medium sink can thus be prevented.

Preferably, in the neutral position also, the inflow space and the return flow space are connected to the high pressure space and separated from the low pressure space. This and the last-named aspect are realized, for instance, by virtue of the fact that the control edges via which a pressure medium connection between the high pressure space and the inflow space and between the high pressure space and the return flow space are controlled have a negative overlap, whereas control edges via which a pressure medium connection between the inflow space and the low pressure space and between the return flow space and the low pressure space are controlled have a positive overlap.

In a preferred embodiment, the control edges of the annular spaces and of the valve slide are mutually coordinated in such a way that, along a follow-up stroke of the valve slide, which follows the initial stroke, the inflow space is connected only to the high pressure space, and the return flow space only to the low pressure space.

In a preferred embodiment, the desired value of the pressure at the or downstream of the pressure medium outlet of the pressure reducing valve, in particular the desired value of the feed pressure, lies within a range between about 5 to 15 bar. Particularly preferably, the desired value is about 10 bar. Preferably, the desired value is chosen such that it is smaller than the pressure in the inflow and, in particular, in the return flow. In this way, an unnecessary replenishment is prevented.

In a preferred embodiment, the second hydraulic machine is configured as a slow-speed motor. Since a slewing gear has to be driven at an only slow speed, an otherwise necessary transmission between the second hydraulic machine and the slewing gear can then be dispensed with.

In a preferred embodiment, the second hydraulic machine is configured as a radial piston machine, since this construction is particularly suitable as a slow-speed motor.

The first hydraulic machine is preferably designed as a high-speed machine, in particular as an axial piston machine in swash plate construction or in bent-axis construction.

In a preferred embodiment, via the first hydraulic machine not only is the second hydraulic machine supplied with pressure medium, but the drive has also at least one further hydrostatic consumer, for instance a hydraulic cylinder for driving a work tool.

The operation of the first hydraulic machine in the open hydraulic circuit lends itself, in particular, to the supplying of consumers of which at least one has a differential volume, so that all consumers—including those with differential volumes—can be supplied with pressure medium by just one hydraulic machine. This proves simpler in terms of equipment, and more cost-effective, than to have in place a closed hydraulic circuit for the second hydraulic machine and additionally an open hydraulic circuit for the other consumers, respectively having an own first hydraulic machine (pump).

If the second hydraulic machine is, for instance, the sole hydrostatic consumer connected to the first hydraulic machine and it has no differential volume, then it is also of course possible, however, to operate the two hydraulic machines in the closed hydraulic circuit.

In terms of equipment, a embodiment in which the drive has a control block for controlling the supply of pressure medium to the second hydraulic machine and to each further hydrostatic consumer which is present is particularly compact. For each of the consumers and for the second hydraulic machine, the control block here preferably has respectively a valve section. For the second hydraulic machine, the valve section preferably has the aforementioned control valve.

Preferably, the first hydraulic machine is designed with adjustable displacement volume.

In a preferred embodiment, the hydrostatic drive has a prime mover, which is coupled with the first hydraulic machine and can be driven via this latter. The prime mover is configured, for instance, as an electric motor or as an internal combustion engine, in particular as a diesel engine.

### BRIEF DESCRIPTION OF THE DRAWING

The figure depicts an embodiment of a hydrostatic drive according to the disclosure.

### DETAILED DESCRIPTION

According to the illustrative embodiment shown in the figure, a hydrostatic slewing gear drive 1 of an excavator (not represented) has a first hydraulic machine, which is designed as a pump, in particular as an axial piston pump 2, with adjustable displacement volume, and a second hydraulic machine, which is designed as a hydraulic motor, in particular as a radial piston motor 4, as is known from data sheet RD 15214 of the Applicant. The axial piston pump 2 is coupled with a prime mover 3 and is driven by this same, the radial piston motor 4 is coupled via a driving shaft 6 with a slewing gear (not represented) of the excavator. Preferably, the axial piston pump 2 is load-sensing regulated. It thus sets its delivery volume respectively such that the pump pressure lies, by a specific pressure difference within the range from 10 to 30 bar, above the highest load pressure of all simultaneously activated consumers. If the pump detects no load pressure, then the pump pressure is precisely as high as the stated pressure difference.

The hydrostatic drive 1 has a valve control block 8, via which a supply of pressure medium to the radial piston motor 4 and to a hydrostatic consumer 10, configured as a differential cylinder, of the drive 1 is controllable. For the supply of pressure medium to the radial piston motor 4 said hydrostatic drive has a valve section 12, and for the supply of pressure medium to the hydrostatic consumer 10 it has a valve section 14. The valve control block 8 can be extended by further valve sections for the supply of pressure medium to additional hydrostatic consumers of the excavator. Each of the valve sections 12, 14 has a control valve (not represented) for the respective hydrostatic consumer 4, 10. The control valves here have a load-sensing function, so that the hydraulic consumers can be supplied with pressure medium simultaneously and, in particular, independently of load, thereby making it easier for an operator to control the various consumers and the slewing gear.

The valve control block 8 has a pump connection P, which is connected to a high pressure connection of the axial piston pump 2, and a tank connection T, which is connected via a low pressure line 36 to a pressure medium sink configured as a tank T. In the low pressure line 36 is disposed a spring-loaded check valve 38, which opens toward the tank T and via which the low pressure line 36, in the shown illustrative embodiment, is pretensioned to a pressure of three bar.

The low pressure line receives return flow volume flows of all consumers 4, 10 and discharges these into the tank T, from which, in turn, the axial piston pump 2 sucks up pressure medium via a low pressure line 40. To the tank T is connected a leakage line 42 of the radial piston motor 4.

The supply of pressure medium to the radial piston motor 4 is realized via an inflow channel 16, via which a working connection A of the valve section 12 is connected to a working connection

A of the radial piston motor 4. A working connection B of the radial piston motor 4 is fluidically connected via a return flow channel 18 to a working connection B of the valve section 12. The inflow channel 16 is protected against overload with a pressure limit valve 20, the pressure medium outlet of which is connected to the return flow channel 18. Much the same applies to the return flow channel 18, which is protected via an identical pressure limit valve 20 toward the inflow channel 16. The supply of pressure medium to the radial piston motor 4 can be reversed via the control valve of the valve section 12 by the pressure medium connections P to A and B to T being switched to P to B and A to T. In this way, the rotational direction of the radial piston motor 4, and thus of the slewing gear, can be altered.

A high pressure connection of the axial piston pump 2 is connected via a feed line 22 to a pressure medium inlet 24 of a pressure reducing valve 26. The pressure medium outlet 28 thereof is connected via a feed line 30 to a feed connection M of the radial piston motor 4. At the feed connection M, the feed line 30 branches, wherein a first branch can be fluidically connected to the return flow channel 18 via a check valve 32 which closes toward the feed connection M, and a second branch can be fluidically connected to the inflow channel 16 via a second, identical check valve 32 which closes toward the feed connection M. In the shown illustrative embodiment, the check valves 32 have only a small opening pressure difference of about 0.5 bar, above which a pressure medium connection from the feed connection M into the inflow channel 16 or return flow channel 18 is freed.

The pressure reducing valve 26 has an adjustable spring 34, the pressure equivalent of which acts on a valve body (not represented) of the pressure reducing valve 26 in the direction of a pressure medium connection of the pressure medium inlet 24 to the pressure medium outlet 28. This pressure equivalent is counteracted by the pressure tapped at the pressure medium outlet 28, which pressure is substantially equal to the feed pressure at the feed connection M. The pressure here acts on a control surface, acting against the spring 34, of the valve body, which latter is designed as a valve slide. The pressure equivalent thus represents a desired value of the pressure regulated at the pressure medium outlet.

In normal operation, via the control valve of the valve section 12, pressure medium is fed from the axial piston pump 2, for instance, into the inflow channel 16 and so the radial piston motor 4 is driven, whereby the slewing gear, inclusive of its superstructure, executes a rotation. Let us now assume an abrupt interruption of the pressure medium supply, for instance through the release of a joystick by which the rotary motion is controlled. The inertia of mass of the slewing gear leads to the radial piston motor 4, in this operating state, now being driven by the slewing gear and changing over to pump operation. This results in a build-up of pressure in the return flow channel 18, since this is closed off against the tank T via the control valve. In the inflow channel 16 the pressure falls sharply, since this is separated via the control valve from the supply of pressure medium to the axial piston pump and the second hydraulic machine 4 continues during pump operation to suck up from the inflow channel 16. There is consequently a threat of cavitation. This is reliably prevented, however, by the pressure reducing valve 26, since this regulates the feed pressure at the feed connection M specifically to the desired value—in this illustrative embodiment about 10 bar—which is necessary to ensure a sufficient feed volume flow into the inflow channel 16. This desired value has been determined beforehand in the layout of the drive 1 for the described scenario and has been set at the spring 34. In this context, it is particularly advantageous that the replenishment, as a result of the comparatively high feed pressure provided by the pressure reducing valve 26 compared with the prior art, which for the replenishment merely provides check valves subjected to tank pressure, extends over a significantly shorter period, say in the order of magnitude of one second or a fraction of a second. To permanently provide such a high pressure in the tank line would be barely acceptable from energy-related viewpoints. Due to the load-sensing regulation of the pump 2, a sufficiently high pressure is present at the pressure medium inlet 24 of the pressure reducing valve 26.

Disclosed is a hydrostatic drive for a slewing gear of a stationary or mobile work machine, in particular an excavator or crane. The drive has a hydraulic pump and a hydraulic motor driven by the hydraulic pump. Said hydraulic motor is here coupled with the slewing gear. The drive further has a pressure reducing valve, which can be subjected to pressure medium by the hydraulic pump or another pressure medium source of the drive and via which a pressure at a feed connection of the hydraulic circuit can be purposefully regulated.

### REFERENCE SYMBOL LIST

1 hydrostatic drive
2 axial piston pump
3 prime mover
4 radial piston motor
6 driving shaft
8 valve control block
10 hydrostatic consumer
12, 14 valve section
16 inflow channel
18 return flow channel
20 pressure limit valve
22 feed line
24 pressure medium inlet
26 pressure medium outlet
30 feed line
32 check valve
34 spring
36 low pressure line
38 check valve
40 low pressure line
42 leakage line

What is claimed is:

1. A hydrostatic drive for a slewing gear, comprising:
a first hydraulic machine configured to be coupled with a prime mover;
a second hydraulic machine configured to be coupled with the slewing gear;
an inflow channel fluidly connecting the first hydraulic machine and the second hydraulic machine, the first hydraulic machine configured to supply the second hydraulic machine with pressure medium via the inflow channel;
a return flow channel fluidly connecting the second hydraulic machine to a pressure medium sink of the hydrostatic drive, the second hydraulic machine configured to discharge pressure medium to the pressure medium sink via the return flow channel;
a feed connection configured, in order to compensate a leakage or a differential volume flow between the inflow channel and the return flow channel, to be selectively fluidically connected: (i) to the inflow channel when a pressure of pressure medium within the inflow channel is higher than a pressure of pressure medium within the return flow channel, and (ii) to the return flow channel when the pressure of pressure medium within the return flow channel is higher than the pressure of pressure medium within the inflow channel;
a pressure reducing valve having a pressure medium inlet configured to be fluidically connected to the first hydraulic machine or to another pressure medium source of the drive; and
a pressure medium outlet configured to be fluidically connected to the feed connection and further configured to regulate a feed pressure between the pressure medium outlet and the feed connection.

2. The hydrostatic drive according to claim 1, wherein the pressure medium outlet is fluidically separable from the pressure medium sink.

3. The hydrostatic drive according to one claim 1, wherein the pressure medium outlet is fluidically connectable only to the feed connection.

4. The hydrostatic drive according to claim 1, further comprising:
a continuously adjustable control valve configured to control the supply of pressure medium to the second hydraulic machine, the control valve defining a valve bore and including a valve slide slidably positioned in the valve bore, the valve bore having radially extended annular spaces,
wherein a first of the radially extended annular spaces is a high pressure space that is connectable to the first hydraulic machine;
wherein a second of the radially extended annular spaces is an inflow space connectable to the inflow channel;
wherein a third of the radially extended annular spaces is a return space connectable to the return channel;
wherein a forth of the radially extended annular spaces is a low pressure space connectable to the pressure medium sink; and
wherein the valve slide has control edges that are mutually coordinated with the annular spaces such that, along an initial stroke of the valve slide out of a neutral position, the inflow space and the return flow space are fluidically connected to the high pressure space and separated from the low pressure space.

5. The hydrostatic drive according to claim 4, wherein the control edges are mutually coordinated such that, in the neutral position, the inflow space and the return flow space are fluidically connected to the high pressure space and fluidically separated from the low pressure space.

6. The hydrostatic drive according to claim 4, wherein the control edges are mutually coordinated such that, along a follow-up stroke of the valve slide, which follows the initial stroke, the inflow space is connected only to the high pressure space, and the return flow space is connected only to the low pressure space.

7. The hydrostatic drive according to claim 1, wherein the second hydraulic machine is a slow-speed radial piston motor.

8. The hydrostatic drive according to claim 1, wherein pressure at the pressure medium outlet is between 5 bar and 15 bar.

9. The hydrostatic drive according to claim 1, further comprising at least one further hydrostatic consumer configured to be supplied with pressure medium via the first hydraulic machine.

10. The hydrostatic drive according to claim 1, further comprising:
a valve control block configured to control a supply of pressure medium to the second hydraulic machine via a first valve section, and further configured to control at least one further hydrostatic consumer of the drive via a second valve section.
